(19) United States
(12) Patent Application Publication
(10) Pub. No.: US 2024/0152113 A1
(43) Pub. Date: May 9, 2024

(54) CNC lathe control system based on graphic interaction and control method thereof

(71) Applicant: Yangzhou Chuangxin Tech Co., Ltd., Yangzhou, Jiangsu (CN)

(72) Inventors: Yonglai YANG, Yangzhou, Jiangsu (CN); Youqi YANG, Yangzhou, Jiangsu (CN); Jinzhu YAO, Yangzhou, Jiangsu (CN); Chunwang FAN, Yangzhou, Jiangsu (CN)

(21) Appl. No.: 17/771,066

(22) PCT Filed: Jan. 19, 2022
(86) PCT No.: PCT/CN2022/072768

§ 371 Date: Apr. 22, 2022

(30) Foreign Application Priority Data
Oct. 14, 2021 (CN) 2021111963474

(51) Int. Cl. G05B 19/4097; G06F 30/12; G06F 111/20

(52) U.S. Cl. CPC G05B 19/4097; G06F 30/12; G05B 2219/32128; G05B 2219/33099; G05B 2219/45136; G06F 2111/20

(57) ABSTRACT

A CNC lathe control system based on graphic interaction includes a CNC lathe, an upper computer and a lower computer, the upper computer and the lower computer communicate with each other, the lower computer is integrally connected with a CNC lathe body and communication is established between the lower computer and the CNC lathe body, the upper computer includes a control unit, and the control unit is used to realize graphic interactive input, process parameter setting, tool path calculation, automatic generation, simulation and verification of CNC machining codes. The system can interactively draw graphics and hierarchically manage and set parameters of processes, which is highly intuitive and greatly improves the intelligent control level of CNC lathes.

### TECHNICAL FIELD

The present invention relates to the technical field of CNC lathes, in particular to a CNC lathe control system based on graphic interaction and control method thereof.

### BACKGROUND TECHNOLOGY

Small CNC lathes are machining technologies developed on the basis of computer control technology. Traditional CNC lathes have following processing steps: first designing and editing graphics of parts to be machined via graphic display software, and then converting the above-designed part machining graphics into CNC lathe machining files with CNC code generation software, copying the converted CNC lathe machining files into CNC lathe control memory, generating corresponding tool operation instructions, and controlling tool operations to complete CNC lathe machining of parts through tool actuators. It can be known that during processing of traditional CNC lathes, computers, graphic editing software, CNC code generation software, lathe controllers, and lathe execution components are all independent systems that complete tasks respectively on their own.

When it comes to operate existing small CNC lathes, only those technical personnel who have received professional technical training can make it, and operations often include use of graphic editing software, CNC machining code generation, and operation methods of CNC lathes. Especially when to machine parts with complex structures, the technical personnel needs to spend a lot of time in converting graphics and CNC machining codes manually, and once errors occur in the conversion process, it is difficult to notice and find them.

### SUMMARY OF THE INVENTION

The present invention aims to provide a CNC lathe control system based on graphic interaction and control method thereof, wherein the control system has functions of graphic interactive input, process parameter setting, automatic tool path calculation and automatic generation of numerical control machining codes, hierarchical management of graphics is applied to set process parameters, and the control system is characterized by high efficiency, strong intuition and flexible operation.

In order to achieve above purposes, the present invention adopts following technical solutions:

A CNC lathe control system based on graphic interaction, comprises a CNC lathe, an upper computer and a lower computer, the upper computer and the lower computer communicate with each other, the lower computer is integrally connected with a CNC lathe body and communication is established between the lower computer and the CNC lathe body, the upper computer includes a control unit, wherein the control unit is used to realize graphic interactive input, process parameter setting, tool path calculation, and automatic generation, simulation, and verification of CNC machining codes; and the control unit includes at least one terminal device equipped with human-machine interface which can execute operating instructions through at least one control software module.

As a further improvement on the present invention, the terminal device includes an intelligent device for operating man-machine interface software and storing, displaying, and outputting related control programs and control parameters, and an input device for drawing and editing graphics and inputting and controlling related parameters; and
the intelligent device comprises
a graphic interactive editing module for realizing graphic drawing and editing through a basic geometric graphic library,
a process parameter setting module for interactive input of various parameters of machining processes which include selecting types and tool parameters of machining processes from a process database and a tool library respectively,
a process planning module, configured to generate files of the machining processes according to graphics and process parameters, and
a simulation verification module for simulating the machining processes in graphic forms.

As a further improvement on the present invention, the intelligent device includes at least any one of a computer, a tablet computer or a mobile phone.

As a further improvement on the present invention, the control unit also includes a motion controller which is used for speed planning and motion interpolation calculation of machining data.

As a further improvement on the present invention, the CNC lathe is provided with a control panel and the control panel is provided with function keys for manual control of the CNC lathe.

A control method of the CNC lathe control system based on graphic interaction, comprises following steps:
S1: starting a power supply of the control unit to enter the man-machine interface, and employing a graphic edition tool to draw the graphics of work pieces to be machined;
S2: setting the process parameters and color layers for current settings;
S3: setting each of the machining processes and processing parameters thereof, and setting corresponding color layers;
S4: according to the edited graphics and the set process parameters, automatically performing tool path calculation to obtain tool path diagrams;
S5: after completing setting of all the process parameters, generating automatically CNC machining files and displaying CNC machining codes in view of the tool path diagrams;
S6: simulating and verifying the CNC machining codes, and outputting the same to a motion controller after verification is passed; and
S7: outputting to the lathe to realize CNC machining of the work pieces after the motion controller performs speed planning and motion interpolation calculation on the machining data.

As a further improvement on the present invention, the graphic edition tool includes a basic geometric figure library, from which pre-stored points, lines, surfaces and basic geometric figures composed of points, lines and surfaces are selected to draw the graphics of the work pieces.

As a further improvement on the present invention, setting of the process parameters comprises selecting machining processes from a process database and selecting tool parameters from a tool library.

As a further improvement on the present invention, the machining processes in the process database include face lathing, lathing outer circles, lathing inside holes, cutting grooves, and lathing threads, and parameters of any of the machining processes are preset with default values.

As a further improvement on the present invention, the tool parameters in the tool library include types of the tools and cutting parameters.

Compared to the prior art, the present invention has following beneficial effects: disclosed is a CNC lathe control system based on graphic interaction, wherein graphic drawings and edition are directly completed in a system interface, the system automatically performs tool path calculation and generates tool path diagrams, process parameters are set in the system interface so that the system automatically generates numerical control machining codes which are then simulated and verified, after passing verification, the system outputs the same to a motion control unit, and a motion controller performs speed planning and motion interpolation calculation on machining data, and outputs the same to a lathe to complete the NC machining of work pieces; in the present invention, that tool paths are obtained in graphics and numerical control machining codes are generated automatically greatly improve the intelligent control level of CNC lathes; the hierarchical management of graphics is applied to process parameter setting, which is highly intuitive; through the intelligent control unit that combines graphic processing and motion interpolation technology, efficient, flexible and convenient operation of CNC lathes is realized, the problem that it is difficult for most lathe operators to make CNC machining code programming is solved, thereby reducing the technical threshold of operators and simplifies the operation steps; and through a control panel arranged on the lathe, the CNC lathe is furnished with both automatic control and manual control functions at the same time.

### BRIEF DESCRIPTION OF THE DRAWINGS

FIG. 1 is a structural block diagram of the CNC lathe control system based on graphic interaction; and

FIG. 2 is a man-machine interface diagram of the CNC lathe control system based on graphic interaction.

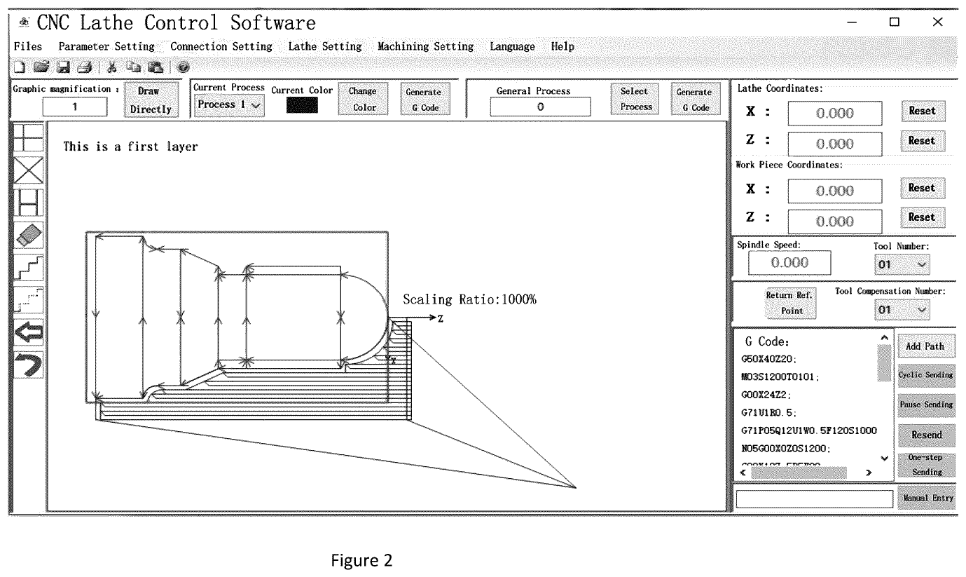

### SPECIFIC EMBODIMENTS

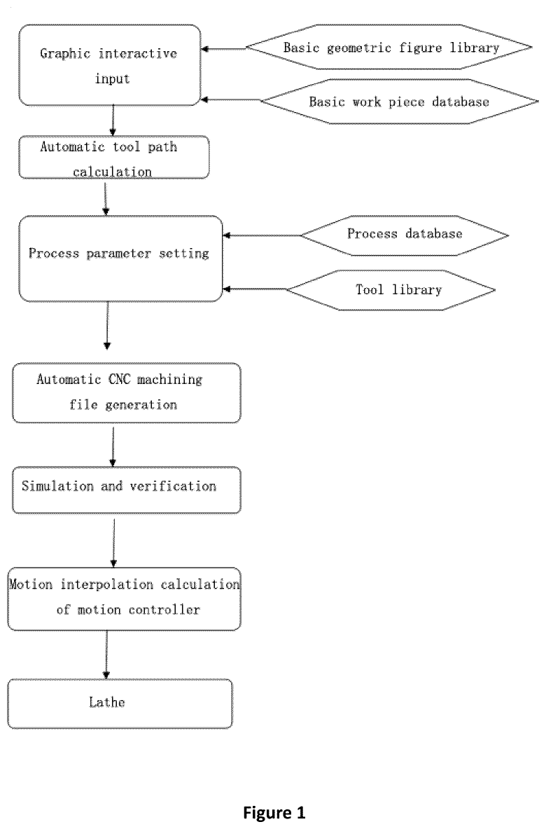

The following is a clear and complete description of the technical solutions in embodiments of the present invention in combination with attached FIGS. 1˜2. Obviously, the described embodiments are only some of the embodiments of the present invention instead of all embodiments. Based on the embodiments of the present invention, all other embodiments obtained by ordinary technical personnel in the field without making creative labor shall belong to the protection scope of the present invention.

As shown in the FIGS. 1˜2, the present invention provides a CNC lathe control system based on graphic interaction, comprising a CNC lathe, an upper computer and a lower computer, the upper computer and the lower computer communicate with each other, the lower computer is integrally connected with a CNC lathe body to realize mutual communication, the upper computer includes a lathe and a control unit which realizes a communication connection with the lathe, wherein the control unit is configured to realize graphic interactive inputs, process parameter settings, tool path calculation, and automatic generation, simulation and verification of CNC machining codes; and the control unit includes a terminal device equipped with human-machine interface which executes operating instructions through a control software module; the terminal device includes an intelligent device for operating man-machine interface software and storing, displaying, and outputting and controlling related programs and parameters, and an input device for drawing and editing graphics and inputting control-related parameters; the intelligent device includes a graphic interactive editing module for realizing graphic drawing and editing through a basic geometric graphic library, a process parameter setting module for interactive input of various parameters of machining processes which include selecting types and tool parameters of machining processes from a process database and a tool library respectively, a process planning module configured to generate files of machining processes according to graphics and process parameters, and a simulation verification module for simulating the machining processes in graphic forms; the terminal device is specifically at least a computer used to process human-machine interface software, and to store, display, output and control related programs and parameters, or at least a mouse and a keyboard used to draw and edit graphics, and input and control related parameters; in order to improve the machining accuracies of the CNC lathe and make it suitable for machining work pieces with complex structures, the control unit further includes a motion controller which realizes reasonable tool path planning by speed planning and motion interpolation calculation of machining data; in order to realize a manual control of the CNC lathe, the lathe is provided with a control panel, and the control panel is provided with function keys and a hand pulse interface, wherein the function keys include automatic, manual, and emergency stop buttons, manual and automatic function keys are used to realize a free switching between manual control and automatic control of the CNC lathe, and the emergency stop button is used to stop operation of CNC lathe manually in emergency. Through the hand pulse interface, an external hand pulse control can be connected so that movement of tools can be manually controlled; and in order for a further manual control of the CNC lathe, an X-axis motor interface, a Z-axis motor interface, a speed control knob, a spindle start button and a spindle stop button can be mounted on the control panel.

A control method of the CNC lathe control system based on graphic interaction, comprises following steps:
S1: starting a power supply of the control unit to enter a man-machine interface, wherein on a left side of the man-machine interface is provided a graphic edition tool, the graphic edition tool includes a basic geometric figure library and has a figure drawing function, the basic geometric figure library includes points, lines, surfaces and basic geometric figures composed of points, lines and surfaces; in order to enrich the graphics library of graphics editing tools, a basic work piece database can also be added, the basic work piece database includes structures of components commonly used in machining; when drawing and editing graphics, suitable graphics or basic work pieces from the basic geometry library and basic work piece database can be selected to be a basis of drawing and edition, and the drawn graphics can also be directly imported.
S2: setting the process parameters and color layers for the current settings, wherein the setting of the process parameters includes selecting the machining processes from the process database and selecting the tool parameters from the tool library; the processing process parameters in the process database include lathing end faces, lathing outer circles, lathing inside holes, cutting grooves, and lathing threads, and parameters of any one of the machining processes are preset with default values; the tool parameters in the tool library include tool types and cutting parameters, setting of the machining parameters can also include starting points, advance and retraction vectors, machining allowances, feed ratios and rotation velocities of the lathe spindle, etc.; when setting specific parameters, the default values can be directly selected or specific parameters can be manually entered; and
when it comes to directly selecting the work piece structure or work piece position to be set on the graphical interface, selecting a sequence number of the process from a drop-down menu of the process, and selecting a color for the current process, selecting a type of the process from the process database, wherein the parameters for selecting tools from the tool library include tool types and cutting parameters; after setting, the information of the current process is displayed in the selected color on the display interface, which is highly intuitive.
S3: numbering each of the processes and the processing parameters thereof, and setting corresponding color layers and specific parameters;
S4: according to the drawn graphics and the set process parameters including machining processes, tool information and cutting parameters and other data, automatically performing tool path calculation to obtain tool path diagrams, which are to be used in subsequent simulation and verification, and editing and modification, and directly displayed the same in the human-machine interface;
S5: after completing setting of all the process parameters, adding tool paths, generating automatically CNC machining codes and displaying on the man-machine interface; selecting all set process, and automatically generating general CNC machining files;
S6: performing simulation verification on the codes in the general CNC machining files, graphically display machining method of the work pieces on the display interface to simulate the machining trajectory, to verify correctness of the CNC machining files, correcting in time to reduce adjustment time for trial cutting of the work piece if errors are found, and outputting the motion controller after the verification is passed; and
S7: the motion controller performs speed planning and motion interpolation calculation on the machining data to make the tool motion trajectory more accurate, and outputting the calculated and corrected CNC machining codes to the lathe so that CNC machining of the work pieces is achieved.

The CNC lathe control system based on graphic interaction of the present invention has graphic drawing and editing functions, generates tool paths from graphics and automatically generates numerical control machining codes, which greatly improve the intelligent control level of CNC lathes; the hierarchical management of graphics is applied to the setting of process parameters, which is highly intuitive; through the intelligent control unit that combines graphics processing and motion interpolation technology, efficient, flexible and convenient operation of CNC lathes is realized, the problem that it is difficult for most lathe operators to make CNC machining code programming is solved, which reduces the technical threshold of operators and simplifies the operation steps; and through a control panel arranged on the lathe, the CNC lathe has functions of automatic control and manual control at the same time.

What is claimed is:

1. A CNC lathe control system based on graphic interaction, comprising a CNC lathe, an upper computer and a lower computer, wherein the upper computer and the lower computer communicate with each other, the lower computer is integrally connected with a CNC lathe body and communication connection is established between the lower computer and the CNC lathe body; the upper computer includes a control unit configured to realize graphic interactive input, process parameter setting, tool path calculation, automatic generation, simulation and verification of CNC machining codes; and the control unit includes at least one terminal device equipped with human-machine interface which is able to execute operating instructions through at least one control software module.

2. The CNC lathe control system based on graphic interaction according to claim 1, wherein the terminal device includes an intelligent device for operating man-machine interface software and storing, displaying, and outputting and controlling related programs and parameters, and an input device for drawing and editing graphics and inputting control-related parameters; and
the intelligent device comprises
a graphic interactive editing module for realizing graphic drawing and editing through
a basic geometric graphic library,
a process parameter setting module for interactive input of various parameters of machining processes which include selecting types and tool parameters of the machining processes from a process database and a tool library respectively,
a process planning module, configured to generate files of the machining processes according to graphics and process parameters, and
a simulation verification module for simulating the machining processes in graphic forms.

3. The CNC lathe control system based on graphic interaction according to claim 2, wherein the intelligent device includes at least any one of a computer, a tablet computer or a mobile phone.

4. The CNC lathe control system based on graphic interaction according to claim 1, wherein the control unit also includes a motion controller which is used for speed planning and motion interpolation calculation of machining data.

5. The CNC lathe control system based on graphic interaction according to claim 1, wherein the CNC lathe is provided with a control panel and the control panel is provided with function keys for manual control of the CNC lathe.

6. A control method of the CNC lathe control system based on graphic interaction, comprising following steps:
S1: starting a power supply of the control unit to enter the man-machine interface, and employing the graphics editing tool to draw the graphics of work pieces to be machined;
S2: setting the process parameters and color layers for the current settings;
S3: setting each of the machining processes and processing parameters thereof, and setting corresponding color layers;
S4: according to the edited graphics and the set process parameters, automatically performing tool path calculation to obtain tool path diagrams;
S5: after completing setting of all the process parameters, generating automatically CNC machining files and displaying CNC machining codes in view of the tool path diagrams;
S6: simulating and verifying the CNC machining codes, and outputting the same to a motion controller after verification is passed; and
S7: outputting to the lathe to realize CNC machining of the work pieces after the motion controller performs speed planning and motion interpolation calculation on the machining date.

7. The control method of the CNC lathe control system based on graphic interaction according to claim 6, wherein the graphic edition tool includes a basic geometric figure library, from which pre-stored points, lines, surfaces and basic geometric figures composed of points, lines and surfaces can be selected to draw the graphics of the work pieces.

8. The control method of the CNC lathe control system based on graphic interaction according to claim 6, wherein setting of the process parameters comprises selecting machining processes from processes database and selecting tool parameters from a tool library.

9. The control method of the CNC lathe control system based on graphic interaction according to claim 8, wherein the machining processes in the process database include face lathing, lathing outer circles, lathing inside holes, cutting grooves, and lathing threads, and parameters of any of the machining processes are preset with default values.

10. The control method of the CNC lathe control system based on graphic interaction according to claim 8, wherein the tool parameters in the tool library include tool types and cutting parameters.
